(19) United States
(12) Patent Application Publication
(10) Pub. No.: US 2007/0275655 A1
(43) Pub. Date: Nov. 29, 2007

(54) Terminal for relaying data signal

(75) Inventors: Tomoyuki Iwamoto, Nagano (JP); Tomoharu Fujii, Nagano (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD.

(21) Appl. No.: 11/798,717

(22) Filed: May 16, 2007

(30) Foreign Application Priority Data
May 24, 2006 (JP) P.2006-144135

(51) Int. Cl. H04B 3/36

(52) U.S. Cl. 455/7

(57) ABSTRACT

A terminal includes a wireless module for relaying a data signal, a sub-module for relaying the data signal, and a switch which connects the wireless module and the sub-module in parallel, and selects the wireless module or the sub-module to relay the data signal in response to a control signal from a controller provided in the wireless module.

This application claims foreign priority based on Japanese Patent application No. 2006-144135, filed May 24, 2006, the content of which is incorporated herein by reference in its entirety.

### BACKGROUND OF THE INVENTION

1. Field of the Invention

This invention relates to a terminal for relaying a data signal, and particularly, to a terminal for a wireless network designed to cope with a failure of the wireless terminal in the network.

2. Description of the Related Art

A computer network represents a configuration in which a plurality of terminals is connected to each other. Regarding a connection mode of the network, the networks can be roughly divided into a star type network, a bus type network, a loop type network and a mesh type network. The star type network is a network that handles data of a large capacity, while the mesh type network is, usually, a communication network for performing the communication of a small data amount such as sensor data.

Among them, this invention can be applied to the mesh type network, and particularly, to the mesh type wireless network that uses wireless communication. FIG. 3 is a view schematically illustrating the mesh type network. In the drawing, circles designated by 51 to 58 are terminals. In this network, one terminal is connected to a plurality of terminals.

Particularly, the sensor network has the mesh type network configuration in which each wireless terminal relays data. Use of the mesh type network makes it possible to build a wide-area network.

In the sensor network, the data obtained from the sensors are collected and transferred them to a destination terminal via the network. The sensor network is a network that performs communication of a small data amount such as sensor data.

As a specific configuration of FIG. 3, for example, 51 is a server, 52 through 56 are routers, and 57 and 58 are end devices.

FIG. 4 is a diagram schematically illustrating the relay/transmission of data in the mesh type wireless network. Hereinafter, the wireless terminal that transmits data is referred to as a transmission terminal, and the wireless terminal that receives and processes the data is referred to as a destination terminal. Further, the wireless terminal which relays the data is referred to as a relay terminal. FIG. 4 illustrates a state where the data are transferred to the destination terminal 34 from the transmission terminal 31 by being relayed through relay terminals 32 and 33. Broken lines 1r, 2r and 3r represent ranges in which wireless communication is available in transferring the data from the terminals 31, 32, 33 to the next terminal, respectively. For example, a range where the communication with the terminal 31 is available is a range represented by the broken line 1r, and it will be learned that since the wireless terminal 32 is present within this range, the transmission terminal 31 can transmit data to the wireless terminal 32. The same is true for the terminals 32 and 33.

In this example, the wireless terminals 32 and 33 that are present in the communication-available ranges are used as the relay terminals to transmit the transmitted data to the destination terminal 34. For example, when the data received by the relay terminal 32 is not the data transmitted to the relay terminal 32 as the destination, the relay terminal 32 relays the data to the terminal 33 which is present in the communication-available range. The wireless terminal 33, similarly, relays the data to the designation terminal 34.

Wireless Module

A known wireless terminal is constituted by a wireless module 10 shown in a block diagram of FIG. 5. In FIG. 5, the transmitted signals are received by a reception antenna 11, the received signals are processed in the wireless module 10, and the processed signals a retransmitted from a transmission antenna 12. The wireless module 10 has an amplifier 13, a base band circuit 14 and an amplifier 16.

Signal Processing

Signals received by the antenna 11 are amplified by the amplifier 13 and then sent to the base band circuit 14. The amplifier 13 is constituted by an LNA (low-noise amplifier). The base band circuit 14 demodulates the received signals into the signals of base band, performs AD conversion on the signals, and sends the converted digital signals to a microcomputer 15. Specifically, the base band circuit 14 executes the modulation/demodulation operation in MAC (media access control) layer and in physical layer in an OSI (open systems interconnection) model, and performs formation of a data format. The microcomputer 15 executes processes such as delay processing, processing necessary for protocol like generation of Ack signals or the like, and display processing in the wireless module, with respect to the digital signals. Signals processed by the microcomputer 15 and necessary for the subsequent relay, are processed again by the base band circuit 14, and are modulated. The modulated signals are further amplified by an amplifier 16, and are transmitted from the transmission antenna 12. The amplifier 16 is constituted by a power amplifier.

The above wireless terminal often breaks down due to failure in the microcomputer 15 or in the base band circuit 14. When a major part (microcomputer, etc.) in the wireless terminal for relay breaks down or becomes defective and the terminal becomes no longer capable of relaying the data, the data can no longer be transmitted to the destination.

Specifically, if, for example, the relay terminal 32 breaks down in FIG. 4, the data transmitted from the transmission terminal 31 can no longer be relayed, and the data can no longer be transmitted to the destination terminal 34.

To cope with this problem, a technology has been known to retransmit the data by software control. However, even if it is attempted to retransmit the data by software control, the data cannot be transmitted from the transmission terminal 31 to the destination terminal 34 unless the terminal under normal operation is present in the communication-available range.

There is also an idea for establishing a reliable communication network by making every terminal have a double system (JP-A-2002-261767). However, making each of the terminals have a double system means that the cost is doubled.

### SUMMARY OF THE INVENTION

The present invention has been made in view of the above circumstances.

In some implementations, a terminal of the invention comprising:

a wireless module for relaying a data signal;

a sub-module for relaying the data signal; and

a switch which connects the wireless module and the sub-module in parallel, and selects the wireless module or the sub-module to relay the data signal in response to a control signal from a controller provided in the wireless module.

The terminal may be used in a mesh type wireless network.

In the terminal, the controller determines whether the wireless module is under normal operation, relays the data signal via the wireless module when it is determined that the wireless module is under normal operation, and relays the data signal via the sub-module when it is determined that the wireless module is under abnormal operation.

In the terminal, the wireless module and the sub-module have a same pin arrangement.

In the terminal, the wireless module and the sub-module form a package-on-package (POP) structure.

In the terminal, the control signal includes a pull-up signal or a pull-down signal of a microcomputer.

In the terminal, the controller is a microcomputer.

### BRIEF DESCRIPTION OF THE DRAWINGS

FIG. 1 is a block diagram illustrating a configuration according to an embodiment of the present invention.

FIG. 2A is a schematic view of a wireless terminal having a PoP structure, according to the embodiment of the invention.

FIG. 2B is a perspective view of a sub-module for relay.

FIG. 3 is a diagram showing a concept of a mesh type network.

FIG. 4 is a diagram illustrating a relationship between the wireless terminal and its communication range in the mesh type network.

FIG. 5 is a block diagram illustrating a configuration of a wireless module of a related art.

### DESCRIPTION OF THE PREFERRED EMBODIMENTS

The invention will now be described with reference to the drawings.

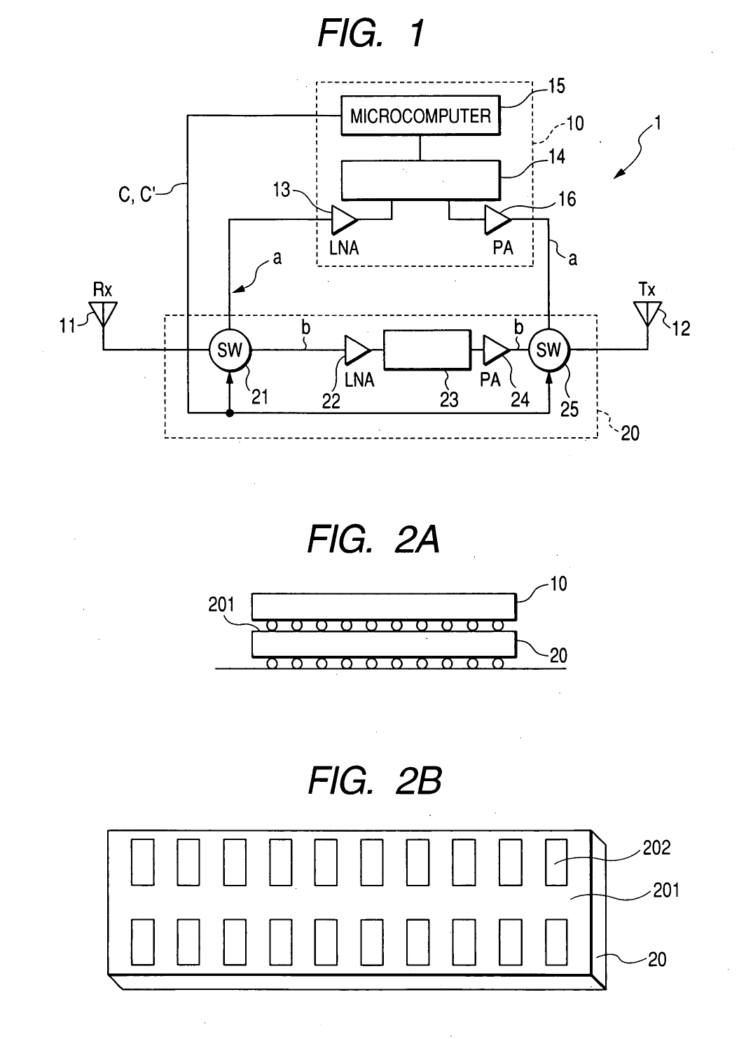

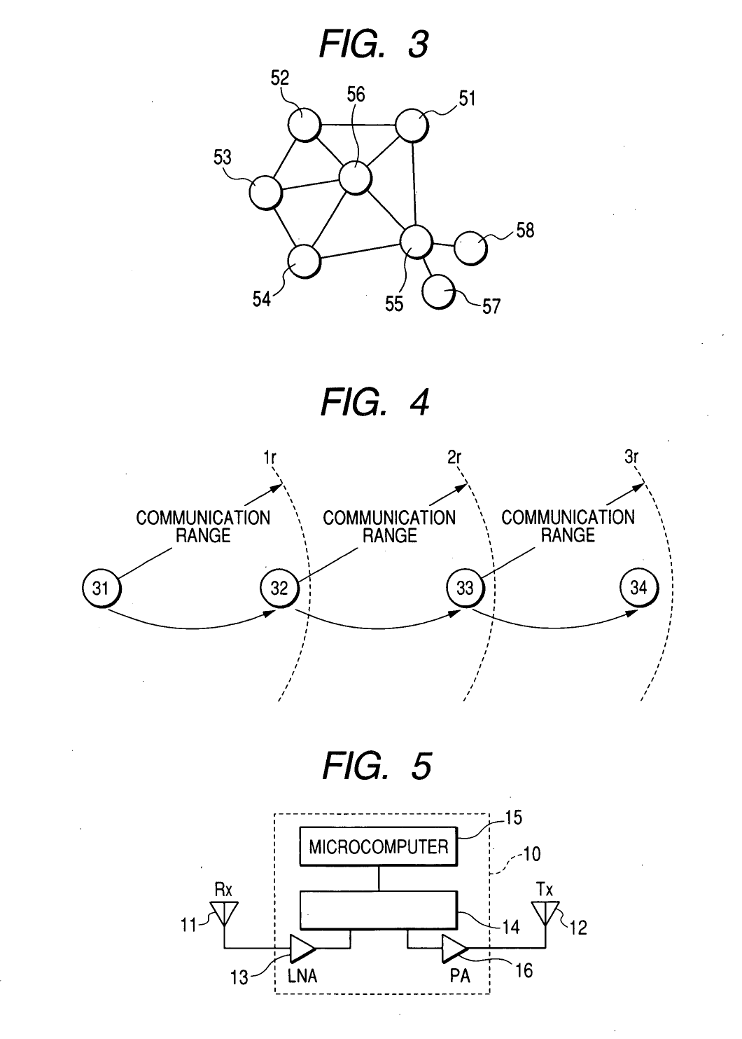

FIG. 1 is a block diagram illustrating a wireless terminal according to an embodiment of the invention. Reference numerals used in FIG. 5 are also used here.

The wireless terminal 1 of this embodiment includes the above-described wireless module 10 and a sub-module 20 for relay that is added in this embodiment of the invention. The wireless module 10 is described above, thus its description is omitted.

Sub-Module for Relay

The sub-module 20 for relay according to the embodiment of this invention is a device having a function for relaying the signals and a function for switching the path. In FIG. 1, a block represented by a broken line 20 is the sub-module for relay. The module 20 includes a first switch 21, a first amplifier 22, a relay circuit 23, a second amplifier 24 and a second switch 25.

Upon receipt of a control signal C from the microcomputer 15, the first switch 21 switches the path to send the signals received by the reception antenna 11 to the transmission antenna 12 via the wireless module (path a) or via the sub-module 20 for relay (path b).

The first amplifier 22 is an LNA that receives the reception signal by the switching by the first switch 21 and amplifies the received signal. The relay circuit 23 is an electronic circuit for relay including at least a delay circuit. The delay circuit prevents howling that occurs when there is no delay between the reception antenna 11 and the transmission antenna 12. Signals sent from the relay circuit 23 are further sent to the second amplifier 24 (which includes a power amplifier), and are further transmitted to a next wireless terminal via the second switch 25 and the transmission antenna 12.

The sub-module for relay may only have a function that is minimized to the relay function. Since the sub-module is not required to have the microcomputer which has limitation in usage environment, the sub-module may be designed to have better environmental resistance than the wireless module, so that the sub-module is less prone to be in failure than the wireless module.

Control Signal C

When the microcomputer is under normal operation, a specified pin of the microcomputer transmits a High (or Low) signal. When the microcomputer breaks down, this pin produces a floating voltage. In this case, a signal for pulling down or pulling up the floating voltage is generated. That is, when the microcomputer breaks down, a pull-down signal (or pull-up signal) is generated and from this signal, it is learned that the microcomputer is in failure. The pull-down signal (or pull-up signal) is used as the control signal C to switch the first switch 21 and the second switch 25.

When the base band circuit 14 breaks down, the microcomputer 15 cannot receive the signal from the base band circuit 14, so the microcomputer 15 determines that the base band circuit 14 is in failure, and sends a second control signal C′ to the first switch 21 and to the second switch 25 to switch the path.

Next, described below is the operation of the sub-module 20 for relay.

When the base band circuit 14 and the microcomputer 15 are under normal operation, the control signal from the microcomputer 15 controls the first switch 21 and the second switch 25 so that the data is relayed through the side of the wireless module 10. That is, the path a is selected. In this case, the data received by the reception antenna 11 is sent to the transmission antenna 12 via the wireless module 10.

However, when the base band circuit 14 or the microcomputer 15 operates abnormally due to failure or the like, the control signal C or the second control signal C′ from the microcomputer 15 controls the first switch 21 and the second switch 25 so that the data is relayed through the sub-module 20 for relay. In this case, the data received by the reception antenna 11 is sent to the antenna 12 on the transmission side through the first amplifier 22, the relay circuit 23 and the second amplifier 24, and is transmitted from the antenna 12.

Therefore, even if the microcomputer or the base band circuit in the wireless module 10 breaks down, the sub-module 20 for relay relays the data, enabling the data to be reliably relayed to the next wireless terminal that is present in the communication-available range.

Packaging of the Wireless Terminals

FIG. 2 illustrates the wireless terminal 1 including the wireless module 10 and the sub-module 20 for relay. FIG. 2A is a view of when the wireless terminal is seen from the side surface. As shown in FIG. 2A, the wireless module 10 and the module 20 for relay have the same pin arrangement. FIG. 2B is a perspective view of the sub-module 20 for relay. Connection portions 202 are formed on a surface 201 of a package of the sub-module 20 for relay correspondingly to the pins of the wireless module 10, so that the pins are connected to the connection portions 202. In order to make the wireless terminal, a package of the wireless module 10 is placed on the surface 201 of the package of the sub-module 20 for relay, and is bonded thereto, and is mounted so as to form a so-called PoP (package on package) structure. The two packages are bonded one above the other, and the signal transmission between them is standardized.

The sub-module for relay may be selectively mounted on only the wireless terminals that require the sub-module for relay, so the burden in cost becomes small. Further, as for the manufacturing of the wireless terminals, the wireless terminal can be simply manufactured by using the PoP structure. Moreover, the motherboard that has been used can also be utilized in manufacturing the wireless terminal according to the present invention. Therefore, the wireless terminal of the invention can be achieved without modifying the constitution of the wireless terminal that originally did not have the sub-module.

According to the invention, the data can be reliably transmitted, and the invention can be easily applied to the existing wireless terminals and therefore, be widely used in the mesh type wireless network. The invention can be further effectively used in the sensor network or the like.

According to this invention, even if it becomes impossible to relay the data due to breakage or the like of principal parts in the wireless terminal that relays the data, the data can be to reliably transmitted to the next wireless terminal. According to this invention, further, a module for relay is simply added to the existing wireless device without the need of changing the constitution of the wireless terminal. Therefore, the invention can be easily put into practice. Besides, the sub-module for relay maybe provided only in the desired terminals, thereby offering advantage in cost, too.

As described above, the sub-module for relay is selectively mounted on only those wireless terminals that require the sub-module for relay. The PoP structure makes it possible to use the same motherboard as the wireless terminal that does not have the sub-module and, therefore, the wireless terminal of the invention can be achieved without modifying the constitution of the wireless terminal that originally did not have the sub-module.

Moreover, the sub-module for relay can be mounted without changing the mounting area on the motherboard. Accordingly, the invention can be put into practice without greatly changing the wireless device that originally did not have the sub-module.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A terminal, comprising:
a wireless module for relaying a data signal;
a sub-module for relaying the data signal; and
a switch which connects the wireless module and the sub-module in parallel, and selects the wireless module or the sub-module to relay the data signal in response to a control signal from a controller provided in the wireless module.

2. The terminal according to claim 1,
wherein the controller determines whether the wireless module is under normal operation, relays the data signal via the wireless module when it is determined that the wireless module is under normal operation, and relays the data signal via the sub-module when it is determined that the wireless module is under abnormal operation.

3. The terminal according to claim 1,
wherein the wireless module and the sub-module have a same pin arrangement.

4. The terminal according to claim 1,
wherein the wireless module and the sub-module form a package-on-package (POP) structure.

5. The terminal according to claim 1,
wherein the control signal includes a pull-up signal or a pull-down signal of a microcomputer.

6. The terminal according to claim 1,
wherein the controller is a microcomputer.

7. The terminal according to claim 1,
wherein the terminal is used in a mesh type wireless network.

8. The terminal according to claim 4,
wherein connection portions are formed on a surface of a package of the sub-module correspondingly to pins of the wireless module, and
the wireless module is mounted on the surface of the sub-module so that the connection portions and the pins are connected, thereby to form the package-on-package structure.
